(19) United States
(12) Patent Application Publication
(10) Pub. No.: US 2024/0039379 A1
(43) Pub. Date: Feb. 1, 2024

(54) Method for Encapsulating or Embedding Components by Resin Transfer Molding, Electrical Machine, and Resin Transfer Molding Device

(71) Applicant: Bayerische Motoren Werke Aktiengesellschaft, Muenchen (DE)

(72) Inventors: Philipp OBERHUMER, Herrsching (DE); Reiner SCHMID, Muenchen (DE)

(21) Appl. No.: 18/017,438

(22) PCT Filed: Aug. 23, 2021
(86) PCT No.: PCT/EP2021/073228

§ 371 Date: Jan. 23, 2023

(30) Foreign Application Priority Data
Sep. 14, 2020 (DE) 10 2020 123 852.5

(51) Int. Cl. H02K 15/12

(52) U.S. Cl. CPC H02K 15/12

(57) ABSTRACT

A method for at least partially encapsulating or embedding components by resin transfer molding includes: placing a component into a mold of a resin transfer molding device; and introducing an embedding material into the mold through a plurality of runners and/or sprues.

### BACKGROUND AND SUMMARY

The present invention relates to a method for encapsulating or potting components, at least in some regions, by means of transfer molding, to an electric machine, and to a device for transfer molding.

In the field of electrical engineering, it is known to embed components at least partially in potting compound. There may be the most diverse reasons for this. In the field of electric machines, embedding in potting compound serves, for example, for the insulation—be it electrical or thermal—and also for the mechanical fixing of components such as windings, for instance, particularly in the case of rotors. In this context, DE 10 2017 219 867 A1 discloses a stator for an electric motor, the stator including a main body, which has been formed from a plurality of laminated stator disks which exhibit an outer ring from which a plurality of teeth extend inward, and a plurality of windings which have been wound around at least some of the teeth, the stator further exhibiting a sealing compound into which the main body of the stator and the windings have been sealed and which integrally forms at least one cooling duct for a cooling medium. Injection molding or transfer molding are mentioned as preferred molding methods for introducing the sealing compound. In this connection, it has turned out that transfer molding is not capable of being readily implemented in practice technically, particularly in the case of large components such as stators or rotors of electric machines. Particularly in the case of potting or encapsulating with thermosetting materials, the known processes are reaching their limits.

It is therefore an object of the present disclosure to specify a method for encapsulating or potting components, at least in some regions, by means of transfer molding, and to specify an electric machine and also a device for transfer molding that optimize the known approaches and, in particular, also enable the use of thermosetting synthetic materials for the transfer molding.

This object may be achieved by a method, by an electric machine, and also by a device according to the independent and dependent claims. Further advantages and features arise out of the dependent claims and also out of the description and the attached Figure.

In accordance with the disclosure, a method for encapsulating or potting components, at least in some regions, by means of transfer molding may comprise the following steps:
inserting a component into a tool of a device for transfer molding;
introducing potting compound into the tool or into a cavity of the tool, in which the component has been arranged, via a plurality of distribution ducts and/or runners.

The introducing of the potting compound via a plurality of distribution ducts and/or runners may enable, on the one hand, a control of the flow-fronts, and hence a control of the procedure for filling the tool cavity, as well as the subdividing of the potting quantity to be introduced into a number of partial quantities. Transfer molding is a method that may be categorized in between compression molding and injection molding. The potting compound—in the present case preferably, in particular, a thermosetting material—is inserted into a corresponding chamber of the device for transfer molding and is pressed into the tool cavity after the tool has been closed. A prerequisite for the method is a readily flowable material which may be available, for instance in the initial state, in the form of pellets. A low-viscosity thermosetting material, in particular a one-component epoxy resin, is preferably used as potting compound. Through the use of a low-viscosity material, the inserts/components in the tool can be treated with care, and even extremely small gaps and openings—such as are present, for instance, in windings of rotors or stators—can be filled.

By the terms “encapsulating” and “potting,” in particular a filling of the components with the potting compound is also understood. The components are infiltrated with the potting compound—that is to say, extremely small gaps and cracks etc. within the component are filled with potting compound. In order to ensure or guarantee the “filling,” in particular the use of the plurality of distribution ducts and/or runners has proved successful in practice.

The device, including the tool, is a device for transfer molding. The tool expediently comprises several mold parts, in particular mold halves. According to a preferred embodiment, the tool comprises two mold halves into which the component can be inserted for the purpose of encapsulating or potting. The tool parts or mold parts accordingly form the tool cavity into which the distribution ducts and/or runners lead. The distribution ducts and/or runners have expediently been arranged in a distributed manner, so that the component to be overmolded or encapsulated can be subjected to transfer molding from several sides/positions. The exact location or positioning of the distribution ducts and/or runners is dependent on, for instance, the geometry and size of the component.

According to one embodiment, the method includes the following step:
conditioning, in particular warming, of the component and/or of the tool prior to introducing the potting compound.

According to one embodiment, the tool is heated. Additionally or alternatively, the component can be warmed up prior to being inserted into the tool. The distribution of the potting compound, or the filling of the mold, can be optimized by both measures.

According to one embodiment, the method includes the following step:
separate feeding of the distribution ducts and/or runners with potting compound.

The distribution ducts and/or runners may be expediently supplied with potting compound individually or separately. According to one embodiment, a distribution duct and/or runner is connected to a chamber or antechamber, the potting compound that is to be pressed in being kept available in the antechamber. According to one embodiment, a plurality of distribution ducts and/or runners—for instance, two or three distribution ducts and/or runners—that lead into the cavity at various points may also extend away from a chamber.

According to one embodiment, the method includes the following step:
introducing varying quantities of potting compound via the distribution ducts and/or runners.

The various chambers may be expediently filled with varying quantities of potting compound. The quantities can expediently be adapted as needed to the component or to the regions that have to be overmolded or potted, in which connection the geometry of the region to be overmolded or potted and also the location and position of the joint-lines as a consequence of the colliding flow-fronts can advantageously be taken into account and influenced.

According to a preferred embodiment, the potting compound is present in the form of pellets. The size of the pellets can advantageously be chosen to be different for each chamber, as a result of which the entire process can continue to be individually matched to the component to be overmolded. The pellets may have any shapes. Cylindrical pellets are often preferred, the size being expediently geared to the component to be filled or to the partial filling being striven for and to the location of the joint-line resulting therefrom.

According to one embodiment, the method correspondingly includes the following step:
using differently-sized pellets for feeding the distribution ducts and/or runners.

According to one embodiment, the method includes the following step:
introducing the potting compound at varying pressures and/or in temporally staggered manner or with varying temporal progressions.

The provision or introduction of the potting compound via the plurality of distribution ducts and/or runners advantageously enables an individual adaptation of the processing pressures and also a variable adaptation of the temporal progression of the entire process. In this connection, the absolute pressure or the actual pressure-level at which the potting compound is introduced may differ from distribution duct and/or runner to distribution duct and/or runner. Alternatively and/or additionally, the pressure profile can also be adapted in line with demand via the various distribution ducts and/or runners.

According to one embodiment, the method includes the following step:
applying an underpressure in the tool.

The tool or tool cavity may be expediently vented, for instance by means of a vacuum pump. This facilitates the filling and reduces the risk of the formation of air-pockets.

According to one embodiment, the method includes the following step:
filling the tool cavity contrary to the force of gravity.

The process of transfer molding or compression may be expediently effected from below, so that a rising and controlled filling is obtained. As a result, no separation or dripping of the potting compound or melt occurs.

According to one embodiment, the component is a rotor or a stator of an electric machine. The electric machine is not restricted to a special type. According to preferred embodiments, the electric machine is a direct-current machine, an asynchronous machine or a synchronous machine, though this listing is not to be understood as being exhaustive.

According to one embodiment, the filling of the mold is undertaken along an axis of the rotor that extends along a rotor shaft.

According to a preferred embodiment, the rotor is a rotor for a current-excited synchronous machine, for instance.

In this case, the rotor includes a plurality of windings, the potting compound having been provided for mechanical fixing, expediently by means of transfer molding. Rotors of permanently excited synchronous machines can also be potted, overmolded or encapsulated with the method. The potting, overmolding or encapsulating of stators is likewise possible. The invention also relates, correspondingly, to an electric machine including a rotor and/or stator that has been produced by the method according to the invention and that has been embedded in potting compound, at least in some regions.

The disclosure further relates to a device for transfer molding, including a plurality of chambers, the chambers being capable of being filled with potting compound and being connected to a tool cavity via distribution ducts and/or runners, the chambers exhibiting actuating elements that have been designed to convey potting compound introduced into the chambers into the tool cavity independently of one another. The actuating elements may be, in particular, cylinders via which the potting compound located in the chambers can be introduced into the tool cavity indirectly via the distribution ducts and/or runners. The cylinders are expediently capable of being controlled or regulated independently of one another. The device expediently may include an arithmetic logic unit that has been designed to drive and/or to regulate the varying actuating elements appropriately.

The advantages mentioned in connection with the method apply equally to the device, and conversely.

### BRIEF DESCRIPTION OF THE DRAWING

Further advantages and features arise out of the following description of a schematically represented embodiment of a device for transfer molding with reference to the attached Figure, which shows:

FIG. 1: a schematic view of an embodiment of a device for transfer molding.

### DETAILED DESCRIPTION OF THE DRAWING

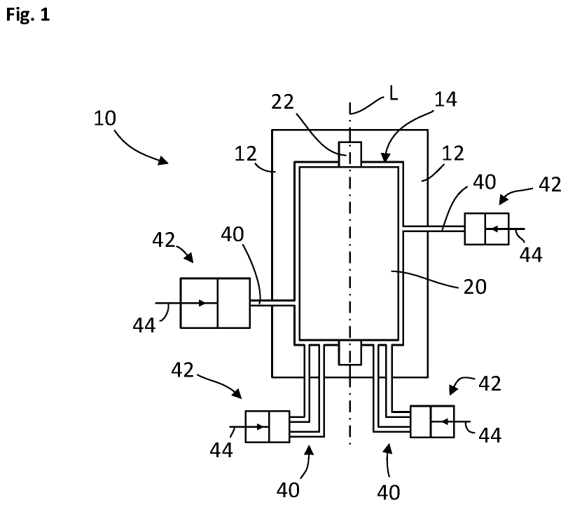

FIG. 1 shows, in a schematic view, an embodiment of a device for transfer molding, including a tool 10 which in the present case comprises two tool halves 12 which form a tool cavity 14. In this cavity, represented schematically, a rotor 20 including a rotor shaft 22 is arranged. A plurality of distribution ducts and/or runners 40, which are respectively connected to chambers 42, lead into the tool cavity 14. The chambers 42 include actuating elements or cylinders 44 via which potting compound located in the chambers 42 can be introduced into the tool cavity 14 via the distribution ducts and/or runners 40. The actuating elements or cylinders 44 are expediently capable of being controlled/regulated independently of one another. The distribution ducts and/or runners 40 lead into the tool cavity 14 at various points or positions. From the example of the rotor 20 it can be discerned, for instance, that the rotor can be subjected to transfer molding both radially and axially. In addition to this, the distribution ducts and/or runners 40 discharge at varying heights relative to a longitudinal axis L which in the present case corresponds to a vertical axis. Besides this, it is also possible that the distribution ducts and/or runners 40 have been distributed in varying manner over the periphery. The distribution ducts and/or runners 40 that have been arranged axially—that is to say, the lower distribution ducts and/or runners 40—may have been arranged, for instance, in distributed manner in the peripheral direction. Overall, an individually adaptable device and an individually adaptable method result which, for instance, also enable the filling of extremely small gaps and cracks with potting compound. In addition, via the distribution of the distribution ducts and/or runners 40 the location of the joint-lines of the flow-fronts can be placed in regions that are not critical from the point of view of the component. This comes about not only via the location of the distribution ducts and/or runners 40 but also via the respective quantity of potting compound that is kept available in the respective chamber 42.

### LIST OF REFERENCE SYMBOLS

10 tool
12 tool halves
14 tool cavity
20 component, rotor, stator
22 rotor shaft
40 distribution duct and/or runner
42 chamber
44 actuating element, cylinder
L longitudinal axis

1-10. (canceled)

11. A method for encapsulating or potting components, at least in some regions, by means of transfer molding, the method comprising:
inserting a component into a tool of a device for transfer molding; and
introducing potting compound into the tool via distribution ducts and/or runners.

12. The method according to claim 11, further comprising:
separately feeding the distribution ducts and/or runners with the potting compound.

13. The method according to claim 11, wherein varying quantities of the potting compound are introduced via the distribution ducts and/or runners.

14. The method according to claim 11, wherein the potting compound is provided in the form of differently-sized pellets.

15. The method according to claim 14, further comprising:
using the differently-sized pellets for feeding the distribution ducts and/or runners.

16. The method according to claim 11, wherein the potting compound comprises a thermosetting material.

17. The method according to claim 15, wherein the thermosetting material comprises a one-component epoxy resin.

18. The method according to claim 11, wherein the potting compound is introduced at varying pressures and/or with temporal offset.

19. The method according to claim 11, further comprising:
applying an underpressure in the tool.

20. The method according to claim 11, wherein the tool includes a tool cavity in which the component has been arranged, and
further comprising:
filling the tool cavity with the potting compound contrary to the force of gravity.

21. The method according to claim 11, wherein the component is a rotor or stator of an electric machine.

22. An electric machine, including a rotor and/or stator that has been embedded in potting compound or potted therewith, at least in some regions, by the method according to claim 11.

23. A device for transfer molding comprising:
a plurality of chambers connected to a tool cavity via distribution ducts and/or runners,
wherein the chambers are capable of being filled with potting compound, and
wherein the chambers include actuating elements configured to convey potting compound introduced into the chambers into the tool cavity.

24. The device according to claim 23, wherein the distribution ducts and/or runners lead into the tool cavity at various points or positions.

25. The device according to claim 23, wherein the distribution ducts and/or runners are arranged at varying heights relative to a longitudinal axis of the tool cavity.

26. The device according to claim 23, wherein the distribution ducts and/or runners are distributed about a periphery of the tool cavity.

27. The device according to claim 23, wherein the actuating elements are controllable independently from one another.
